(19) United States
(12) Patent Application Publication
(10) Pub. No.: US 2013/0010065 A1
(43) Pub. Date: Jan. 10, 2013

(54) ELECTRONIC ENDOSCOPE FOR PROVIDING THREE-DIMENSIONAL IMAGE DATA

(75) Inventor: Kwang-Seog Song, Seoul (KR)

(73) Assignees: MGB ENDOSCOPY CO.,LTD., Seoul (KR); Kwang-Seog SONG, Seoul (KR)

(21) Appl. No.: 13/635,678

(22) PCT Filed: Mar. 4, 2011
(86) PCT No.: PCT/KR11/01505

§ 371 Date: Sep. 17, 2012

(30) Foreign Application Priority Data
Mar. 16, 2010 (KR) 10-2010-0023252

(51) Int. Cl. H04N 13/00

(52) U.S. Cl. 348/45; 348/E13.074

(57) ABSTRACT

This invention is of the electronic endoscope providing 3-dimensional image data which is inserted into the patient's body. It contains the frame in a tube shape forming the hollow; A pair of link members located side by side in the hollow of the frame; The filming part forming the link joint where the moving axis are connected on both side of the back to connect to the end of the link member, filming element where a pair of lens are installed at regular distance on the front, and the illuminator throwing a light on the affected area. It is able to minimize the incision during surgery by minimizing the circumference of the endoscope frame with link member.

### TECHNICAL FIELD

This invention is electronic endoscope providing 3-dimensional image data, which is able to minimize the size of the incision during surgery by reducing the circumference of endoscope frame with link members sliding in and out of the endoscope frame.

### BACKGROUND ART

Typically, endoscope consists of a single tube called direct endoscope. It can be inserted into a patient's body (i.e. inserted through mouth, or through the incision site in surgery. Insertion here refers to the latter for convenience's sake) to observe the inside for treatment and diagnosis so that the doctor can see organs with the naked eye during treatment.

However, this type of endoscope in a single tube provides 2D (2-dimensional, flat) image resulting in lack of cubic effect. This has been causing difficulty in a complete access to the patient's treatment location (the affected area).

As a solution for this problem, we as an applicant have applied for a patent of ‘the endoscope providing 3-dimensional image data’ (application no. 10-2007-0096119). The endoscope described above, as shown in FIG. 1, for the endoscope providing image data while inserted into the patient's body, features a pair of lens (10) parallelized on the front of endoscope; a pair of CCD cameras at the back of the lens pair filming the image on the lens; illuminator (30) on the front exposing light to the effected area.

The existing endoscope mentioned above providing 3-dimentional image data, though, is inserted into the stomach with the 2 cameras fixed on both sides during surgery. Thus, the incision size must be as large as the size of the endoscope's oval-shaped front made by the 2 cameras.

### DISCLOSURE

### Technical Problem

This invention is to solve the problems above by providing electronic endoscope which produces 3-dimensional image data. It minimizes the incision in surgery by minimizing the circumference of endoscope frame with link member sliding in and out of the frame.

### Technical Solution

To solve the problems described above, the electronic endoscope providing 3-dimensional image data for this invention is inserted into the patient's body. It consists of a pair of frames, a tube (100) which produces hollow (110); the central axis (210,210′) aligned on both sides with the hollow (110) of the frame (100), a pair moving up and down with one located in different height to the other within the frame (100) and in the same height outside the frame (100) when moving up, link member (200) connected to both ends of the pair of central axis (210,210′), containing moving axis (220,220′) linked so that they remains parallel within the frame (100) and split outward outside of the frame (100) as the central axis(210,210′) moves; link joint (330) where the moving axis (220,220′) connect on both sides of the back so they can linked with the end of the link member (200). It features a filming element (310,310′) with a pair of lens (311,311′) separated by certain distance on the front and a filming part (300) which forms illuminator (320) throwing a light on the affected area.

Additionally, the filming part (300) is in vertical position toward the internal wall of the frame (100) within the frame (100). As the link member (200) moves, it rotates to face the front from outside of the frame (100) so that it can film the affected area.

Also, there appears a bending (120) in folded shape controlling the direction and the angle of the fore-end (a) on the top of the frame (100).

### Advantageous Effects

As described above, this invention can minimize the incision during surgery by reducing the circumference around the endoscope frame with link member sliding in and out of the endoscope frame.

### DESCRIPTION OF DRAWINGS

FIG. 1 shows the structure of existing electronic endoscope providing 3-dimensional image data.

FIG. 2 shows the structure of this electronic endoscope providing 3-dimensional image data based on recommended application of this invention.

FIGS. 3 through 5 show the operational process of the electronic endoscope providing 3-dimensional image data based on recommended application.

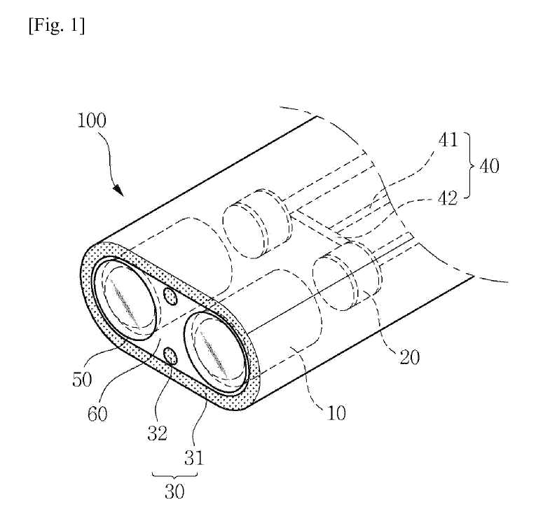

[16] FIG. 6 shows the service condition of electronic endoscope providing 3-dimensional image data based on recommended application.

### MODES FOR CARRYING OUT THE INVENTION

Details of the invention are described below with figures. The same reference mark specified in the figure represents the same member.

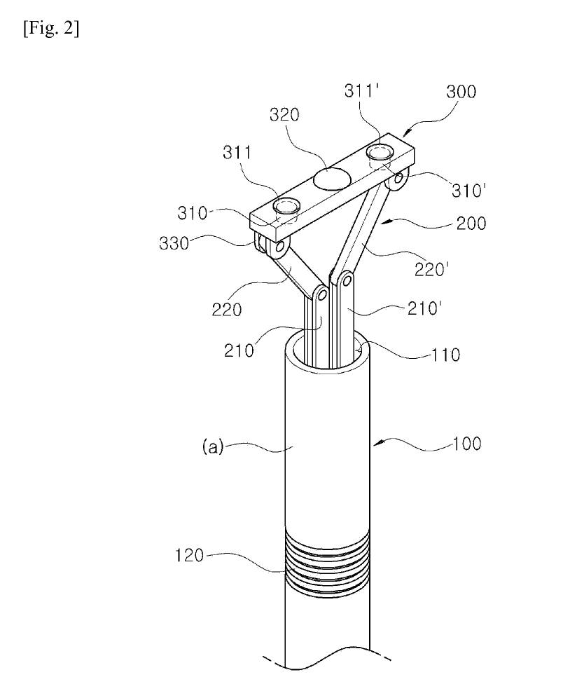

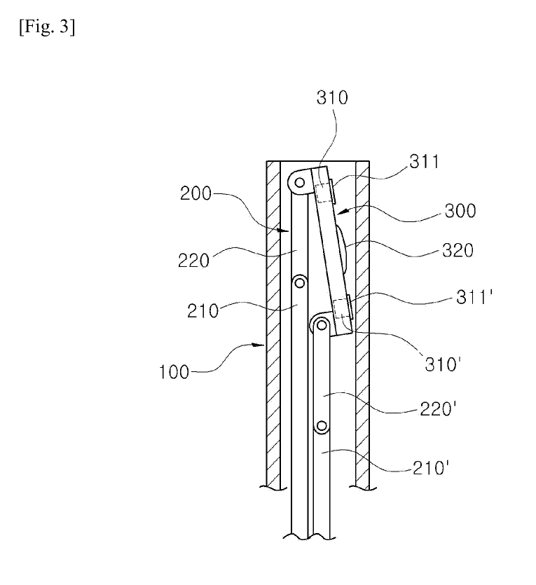

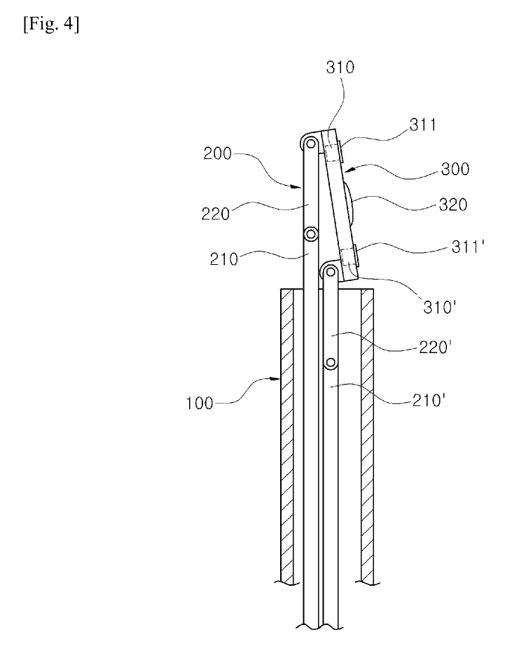

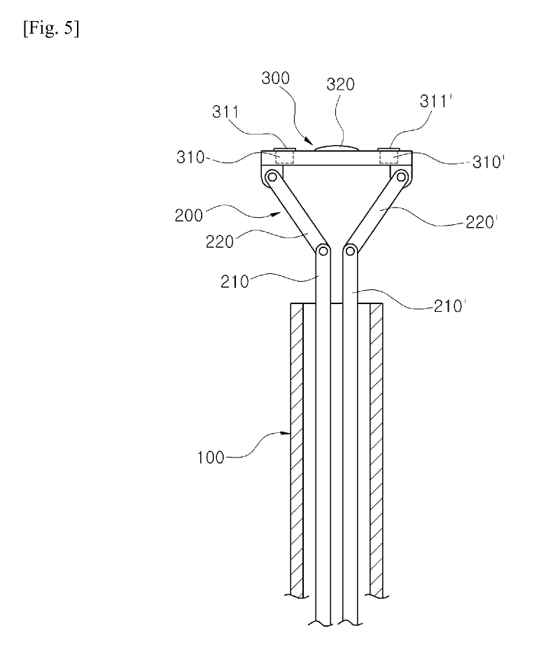

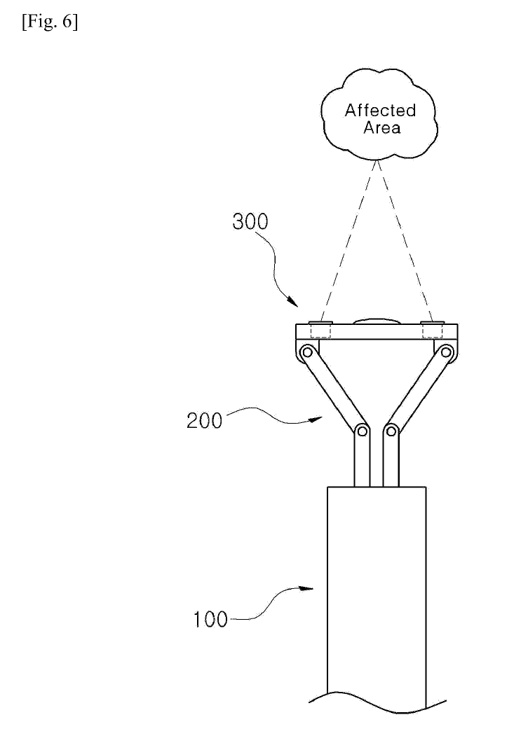

FIG. 2 shows the configuration of electronic endoscope providing 3-dimensional image data based on recommended application, FIG. 3 through 5 operational process, and FIG. 6 service condition.

Seeing FIG. 2 through 6, electronic endoscope providing 3-dimensional image data based on recommended application contain the frame (100), link member (200), and filming part (300).

The frame (100) is inserted into the patient's body and desired to be tube-shaped forming hollow (110) where it can hold link member (200) and filming part (300).

For this invention, it features bending (120) in folded shape controlling the direction and angle of the fore-end of the frame (a). It allows filming the affected area from various points of view by changing only the fore-end (a) without moving the entire frame (100) after the frame (100) is inserted into the patient's body. The appearance of bending (120) should be easy to bend in folded form. There are a variety of mechanical structures available for that.

The link member (200) is located side by side with the hollow (110) of the frame (100) moving up and down. Filming part (300) is connected to the top of the link member.

For this invention, the link member (200) is composed of central axis (210,210′) and moving axis (220,220′) with different height on both sides. When they move upward, controlling the height of the central axis (210, 210′) and the angle of the moving axis (220,220′) changes the position of the filming part (300), minimizing the circumference of the frame (100).

To be specific, the central axis (210,210′) are located on different height when within the frame (100) and on the same height when outside the frame (100) if the user operates it to move upward. When both the central axis (210,210′) move upward, the central axis (210) stops first and the other central axis (210′) keeps moving upward until it reaches the same height as the central axis (210). Then, the moving axis (220,220′) connected to the both ends of the pair of central axis (210,210′) are separated outward when the central axis (210) stops and the central axis (210′) moves upward for the filming part to face the front.

The moving axis (220,220′) remain parallel within the frame (100) and become linked to the central axis (210,210′) to be able to rotate outward when outside the frame (100). It allows the filming part (300) to face the front in order to film the patient's surgery area.

The filming part (300) is connected to the end of the link member (200) to film the surgery area within the patient's body. The link joint (330) is formed where the moving axis (220,220′) are linked to the both sides of the back, allowing the connection to the link member (220).

On the other hand, the filming element (310,310′) where a pair of lens (311,311′) are installed at regular distance and the illuminator (320) throwing a light on the affected area are formed on the front of the filming part (300). The illuminator (320) is located between the lenses (311,311′) to throw a light, easing observation of the surgery area.

For this invention, the filming part (311) is in a vertical position toward the internal wall of the frame (100) within the frame (100). As the link member (200) moves, it rotates to face the front when outside of the frame (100) to film the affected area. Generally, the surgery area is cut in “-shape” or “1 shape”. If a pair of lenses (311,311′) and the filming element (310,310′) are side by side facing the front within the frame (100), the circumference of the frame (100) increases resulting in bigger surgery area. Therefore, the structure of link member should be formed with the filming part (300) in vertical position facing the internal wall of the frame (100) within the frame (100) and facing the front when outside the frame (100). It allows minimizing the incision when inserting the frame (100) into the patient's body.

The examples of the ideal implementation are described in the figures and statement. Although specific terms are used here, it is for the purpose to only describe this invention, not to limit the extent of this invention written in the scope of the request for the patent. Thus, those who have the common knowledge in the technological field would understand that this invention is able to transform to various forms and equivalent implementation examples. The technological protection measures should be planned based on the technological ideology in the scope of the patent request attached.

1. An electronic endoscope which provides 3-dimensional image data, comprising:
a frame in tube shape forming a hollow inserted into a patient's body;
a link member of a pair moving up and down located side by side on both sides of the hollow of the frame, and having central axes which are in different height within the frame and in the same height outside the frame when moving upward and moving axes connected to the both ends of the pair of the central axes which are in parallel position within the frame and linked in separated position outward outside the frame as the central axes move; and
a filming unit having a link joint where the moving axes are connected to the both sides of the back to be connected to an end of the link member and a filming element where a pair of lens are installed at regular distance and an illuminator throwing a light on an affected area of the patient's body;

2. The electronic endoscope which provides 3-dimensional image data according to claim 1, wherein the filming unit is positioned in a vertical direction to face an internal wall of the frame within the frame and rotates to face the front at an outside the frame in order to film the affected area.

3. The electronic endoscope which provides 3-dimensional image data according to claim 1, wherein a bending is formed on a top of the frame to control the direction and angle of a fore-end of the frame.
